(19) United States
(12) Patent Application Publication
(10) Pub. No.: US 2012/0004913 A1
(43) Pub. Date: Jan. 5, 2012

(54) METHOD AND APPARATUS FOR CONTROLLING OPERATION OF PORTABLE TERMINAL USING MICROPHONE

(75) Inventors: Wan-Jae JU, Gyeongsangbuk-do (KR); Byung-Kyu KIM, Gyeongsangbuk-do (KR); Jun-Hui LEE, Gyeongsangbuk-do (KR)

(73) Assignee: SAMSUNG ELECTRONICS CO., LTD., Gyeonggi-Do (KR)

(21) Appl. No.: 13/173,023

(22) Filed: Jun. 30, 2011

(30) Foreign Application Priority Data
Jul. 1, 2010 (KR) 10-2010-0063403

(51) Int. Cl. G10L 15/00

(52) U.S. Cl. 704/246; 704/E15.001

(57) ABSTRACT

A method for controlling an operation of a portable terminal using a microphone includes detecting an operation mode of the portable terminal and driving an audio recognition mode according to the detected operation mode to activate the microphone, converting a signal, inputted through the microphone, into digital data and detecting audio characteristics from the digital data to extract audio analysis data for recognition of a type of the input signal, and determining whether there is UI setting information corresponding to the extracted audio analysis data type and performing a relevant function of the UI setting information.

### CLAIM OF PRIORITY

This application claims the benefit under 35 U.S.C. §119 of a Korean Patent Application filed in the Korean Intellectual Property Office on Jul. 1, 2010 and assigned Serial No. 10-2010-0063403, the entire disclosure of which is hereby incorporated by reference.

### BACKGROUND OF THE INVENTION

1. Field of the Invention

The present invention relates generally to a portable terminal having a microphone, and more particularly, to a method and apparatus for controlling an operation of a portable terminal using a microphone in an environment where the microphone is not usable.

2. Description of the Related Art

Various types of portable terminals based on voice recognition technology have been implemented in areas of number searching and dialing, menu name recognition, inputting messages based on voice-to-text conversion, and song selection during an audio replay.

A portable terminal with a voice recognition function can recognize a registered voice and performs a device control operation based on the recognition outcome.

However, other audio signals not intended for processing may be inputted in the voice recognition-based operation, thus increasing errors. That is, an ambient noise may be inputted through the microphone during a music playing mode or during concerts. Further, in the case of emergencies where a user cannot shout for help, or in public libraries and other venues requiring silence, it may be not feasible to use the voice recognition feature via a microphone.

### SUMMARY OF THE INVENTION

An exemplary embodiment of the present invention is to provide a method and apparatus for controlling an operation of a portable terminal using a microphone, in which a sound generated by an action of a user touching the microphone (not a user's voice inputted through the microphone) is converted into a digital signal, audio analysis data is extracted from the digital signal through noise elimination and amplification for recognition of the generated sound type, and a relevant function corresponding to the extracted audio analysis data and specified in UI setting information is performed, thereby making it possible to control an operation of the portable terminal by inputting a simple contact signal or gesture to the microphone even in the case of emergencies or environments requiring silence.

According to an aspect of the present invention, a method for controlling an operation of a portable terminal using a microphone includes: detecting an operation mode of the portable terminal and driving an audio recognition mode according to the detected operation mode to activate the microphone; converting a signal, inputted through the microphone, into digital data and detecting audio characteristics from the digital data to extract audio analysis data for recognition of a type of the input signal; and determining whether there is User Interface (UI) setting information corresponding to the extracted audio analysis data type, and performing a relevant function of the UI setting information.

According to another aspect of the present invention, an apparatus for controlling an operation of a portable terminal using a microphone includes: a microphone; an analog/digital (A/D) converter converting a signal, inputted from the microphone, into digital data; a memory storing a menu execution command predetermined for each User Interface (UI) setting information type; an audio data processor detecting the audio characteristics of the digital data outputted from the A/D converter, and extracting audio analysis data from the detected data to recognize a type of the input signal; and a controller detecting an operation mode of the portable terminal, driving an audio recognition mode according to the detected operation mode to activate the microphone, searching the memory to determine whether there is UI setting information corresponding to the extracted audio analysis data type, and performing a relevant function of the UI setting information on the basis of the information stored in the memory.

According to yet another aspect of the present invention, a method for controlling an operation of a portable terminal using a microphone includes: detecting a contact or motion signal via the microphone and converting the detected signal into digital data; determining a type of input signal corresponding to the converted digital data; comparing the determined input signal type to a predetermined table having a plurality of User Interface (UI) setting information; and if there is a match between the determined input signal type to one of the UI setting information, performing a corresponding function specified in the matched UI setting information, and if there is no match storing a new UI setting information correspond to the extracted audio analysis data, wherein the signal detected by the microphone comprises an audio signal that is generated by a pointing action including a tap, drag, or click motion by a user.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of an apparatus for controlling an operation of a portable terminal using a microphone according to an exemplary embodiment of the present invention;

FIG. 2 is a flow diagram illustrating a method for controlling an operation of a portable terminal using a microphone according to an exemplary embodiment of the present invention; and

FIGS. 3A to 3C are pictures illustrating waveforms of a signal inputted through a microphone according to an exemplary embodiment of the present invention.

### DETAILED DESCRIPTION OF THE INVENTION

Exemplary embodiments of the present invention will be described below in detail with reference to the accompanying drawings. The present invention may, however, be embodied in different forms and should not be construed as limited to the embodiments set forth herein; rather, these embodiments are provided so that this disclosure will be thorough and complete, and will fully convey the scope of the present invention to those skilled in the art.

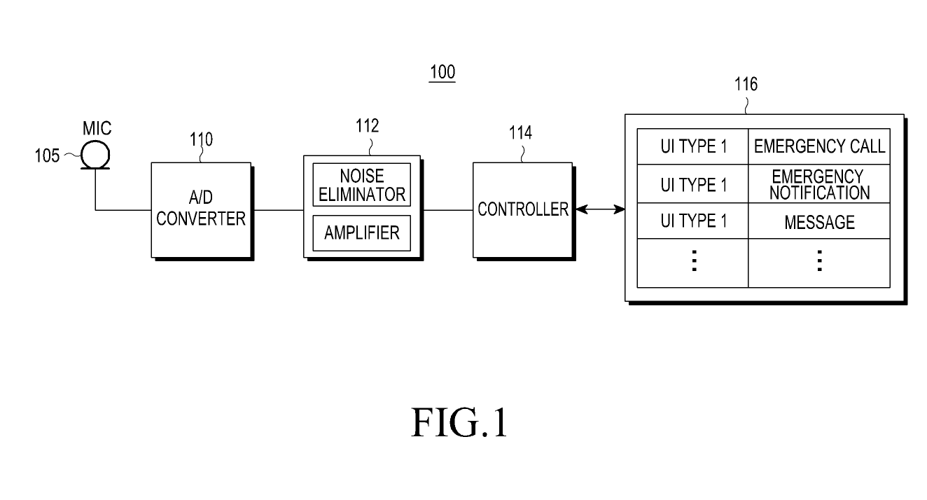

FIG. 1 is a block diagram of an apparatus for controlling an operation of a portable terminal using a microphone according to an exemplary embodiment of the present invention.

Referring to FIG. 1, an apparatus according to an exemplary embodiment of the present invention includes a microphone (MIC) 105 for inputting a user's voice or a sound generated by a user's action, an analog/digital (A/D) converter 110, an audio data processor 112, a controller 114, and a memory 116. The portable terminal 100 may further include a camera, a speaker, and a memory.

It should be noted that the apparatus according to an exemplary embodiment of the present invention may be a mobile terminal having a microphone, or other portable terminals, which may include digital broadcasting terminals, PDA (Personal Digital Assistant), smart phones, and 3G terminals such as IMT-2000 (International Mobile Telecommunication 2000) terminals, WCDMA (Wideband Code Division Multiple Access) terminals, GSM/GPRS (Global System for Mobile communications/General Packet Radio Service) terminals, and UMTS (Universal Mobile Telecommunication Service) terminals. Further, the teachings of the present invention may be applicable to other information communication devices, multimedia devices, and applications thereof.

In operation, the A/D converter 110 receives an analog audio signal from the microphone 105 and converts the analog audio signal into digital data of a predetermined format.

The analog audio signal may be any signal that can be inputted through the microphone 105. Examples of the analog audio signal include human voice signals, sound signals generated by human actions, and other noise signals. The user's action or hand gesture may be any pointing action which include scratching or tapping on or around the microphone 105 with fingers or using user input units (e.g., stylus pens). Other Examples of the user's action may include dragging and clicking.

The audio data processor 112 detects audio characteristics from the digital data outputted from the A/D converter 110, and extracts audio analysis data from the detected data.

The audio data processor 112 includes a noise eliminator and an amplifier. The noise eliminator is configured to eliminate an interference noise from the digital data outputted from the A/D converter 110, and the amplifier is configured to amplify the resulting data obtained by the noise elimination. The audio data processor 112 uses the noise eliminator and the amplifier to detect audio characteristics from the signal inputted from the microphone 105.

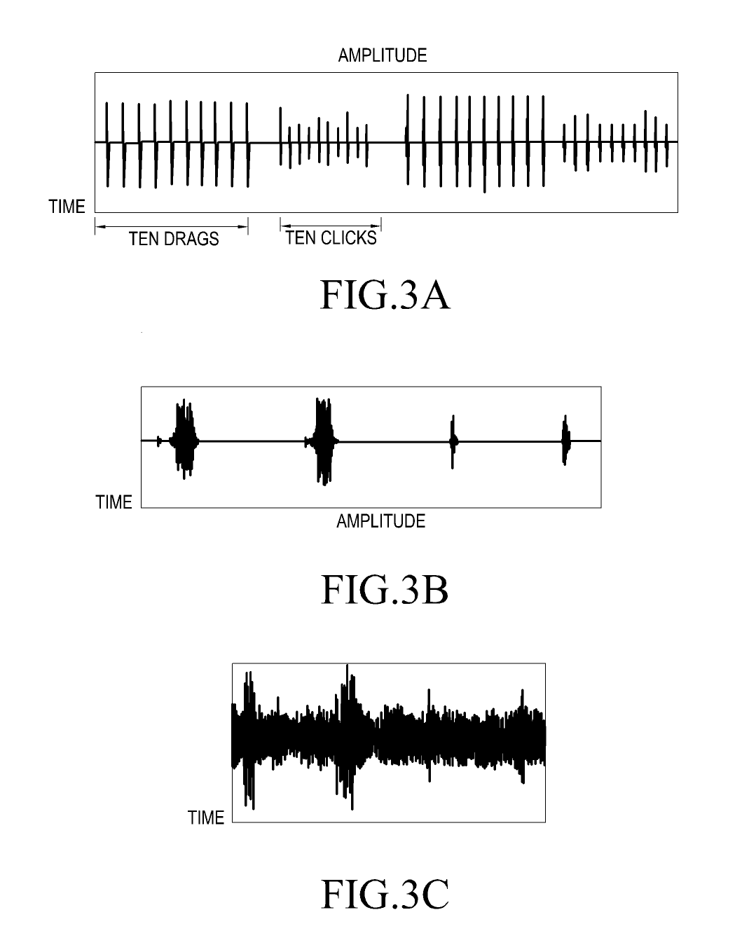

When the user performs a pointing action of scratching or tapping the microphone 105 or a region therearound with fingers or user input units (e.g., stylus pens), different waveforms are generated according to the various contact or action types as illustrated in FIG. 3A. After the sound generated by the pointing action is inputted through the microphone 105, the analog signal inputted through the microphone 105 is converted into digital data. Then, the audio characteristics of a signal inputted by the user from the microphone 105 are detected through noise elimination and amplification, to extract audio analysis data for recognition of a type of the input signal.

The signal generated by the contact or motion signal on or near the microphone 105 may generate waveforms that can be divided from each other according to the signal types as illustrated in FIG. 3A. However, if an external noise is severe, it may generate a waveform as illustrated in FIG. 3C. Therefore, a noise elimination operation is necessary to detect the audio characteristics from the input signal to accurately recognize the audio analysis data. The signal obtained by the noise elimination is amplified by the amplifier as illustrated in FIG. 3B.

The audio characteristics detected through the noise elimination and the amplification are divided from each other according to the action types intended by the user. For example, as illustrated in FIG. 3A, when audio characteristics such as “ten clicks” and “ten drags”, divided from each other, are detected from the input signal, it is recognized as a “click” or “drag” type in order to extract audio analysis data corresponding to the input signal.

The memory 116 stores information and programs that are necessary to operate the portable terminal 100. According to an exemplary embodiment of the present invention, the memory 116 stores a menu execution command predetermined for each UI setting information type. The UI setting information represents predetermined menu execution commands corresponding to the characteristics of the audio analysis data, which are functions supportable by the portable terminal, such as emergency calls, emergency notifications, and emergency messages.

The controller 114 controls an overall operation of the portable terminal 100. The controller 114 detects a current operation mode, and drives an audio recognition mode according to the detected operation mode to activate the microphone 105. The controller 114 searches the memory 116 to determine whether there is UI setting information corresponding to the audio analysis data type extracted by the audio data processor 112. If so, the controller 114 performs a relevant function of the UI setting information on the basis of the information stored in the memory 116.

If there is no UI setting information corresponding to the audio analysis data type extracted by the audio data processor 112, the controller 114 allocates new UI setting information to the extracted audio analysis data type. For example, if the extracted audio analysis data is recognized as “click”, the controller 114 searches the memory 116 to determine whether there is UI setting information corresponding to the audio analysis data type “click”. If the audio analysis data type “click” is not set in the memory 116, the controller 114 enables the user to allocate a new UI setting information corresponding to the audio analysis data type “click”. This may be implemented by registering and storing UI setting information, matched to each audio analysis data type, by the user or designer in the initial operation of the portable terminal 100. Alternatively, it can be implemented by informing that there is no audio analysis data type corresponding to the audio characteristics of a signal currently inputted through the microphone 105, through a display unit (not illustrated) of the portable terminal 100 under the control of the controller 114 during the audio recognition mode, and requesting the user to allocate new UI setting information corresponding to the audio analysis data type of the current input signal.

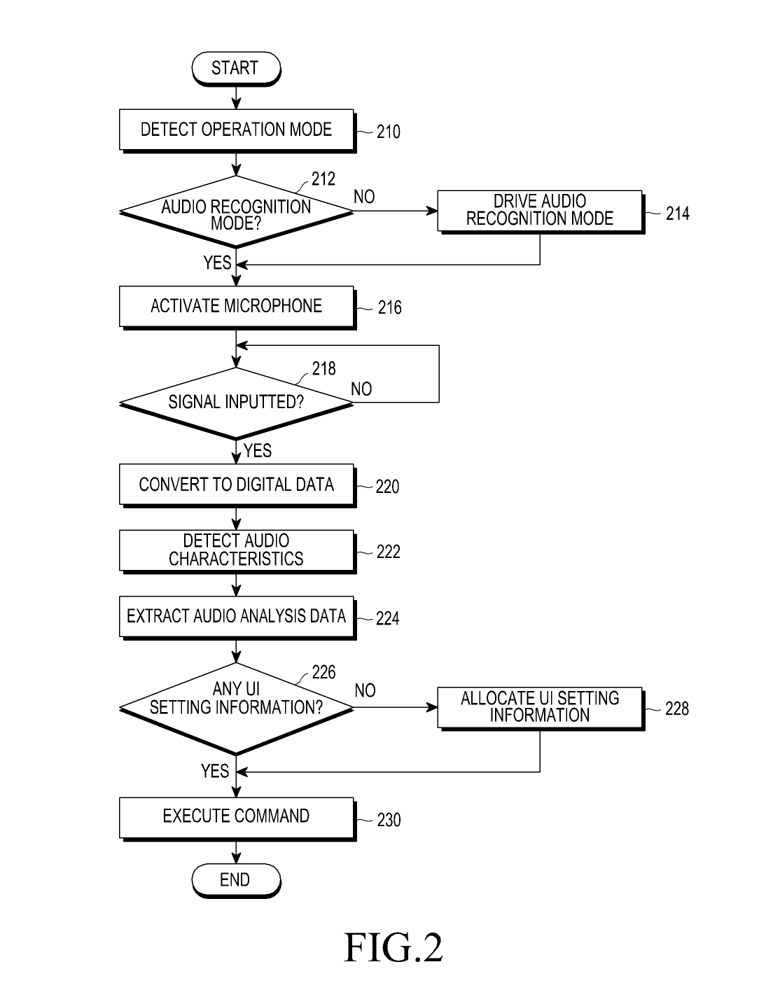

FIG. 2 is a flow diagram illustrating a method for controlling an operation of a portable terminal using a microphone according to an exemplary embodiment of the present invention.

Referring to FIG. 2, a current operation mode of the portable terminal is detected in step 210.

In step 212, it is determined whether the detected operation mode is an audio recognition mode. If the detected operation mode is an audio recognition mode, the microphone is activated in step 216.

In step 218, it is determined whether a signal indicative of hand gesture, a number of tap or click, for example, is inputted through the microphone. If a signal is inputted through the microphone, an analog audio signal inputted through the microphone is converted into digital data of a predetermined format in step 220.

The analog audio signal may be any signal that can be inputted through the microphone. Here, examples of the analog audio signal include human voice signals, sound signals generated by human actions/motion, and other noise signals. The user's action may be any pointing action of scratching, dragging or tapping/clicking the microphone or a region therearound with fingers or user input units (e.g., stylus pens).

In step 222, audio characteristics are detected from the digital data. In step 224, audio analysis data is extracted from the detected data to recognize the type of the signal inputted through the microphone. The audio characteristics are obtained by performing a noise elimination operation and an amplification operation on the digital data, which are divided from each other according to the action types intended by the user using the microphone. That is, it is recognized as a “click” or “drag” type to extract audio analysis data corresponding to the input signal.

In step 226, it is determined whether there is UI setting information corresponding to the extracted audio analysis data type. If there is UI setting information corresponding to the extracted audio analysis data type, a relevant command is executed in step 230. For example, a detection of one click sound via a single tap on the microphone can be set to call home, and two clicks in sequence can be set to call office, etc.

On the other hand, if there is no UI setting information corresponding to the extracted audio analysis data type, a new UI setting information can be allocated to the extracted audio analysis data type in step 228. For example, if the extracted audio analysis data is recognized as “click”, it is determined whether there is UI setting information corresponding to the audio analysis data type. If the audio analysis data type “click” is not set, a new UI setting information corresponding to the audio analysis data type “click” is allocated by the user.

In step 230, a relevant command of the new UI setting information is executed.

Note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

As described above, the present invention converts a sound generated by an action of a user touching a microphone (not a user's voice inputted through the microphone) into a digital signal, extracts audio analysis data through noise elimination and amplification for recognition of the generated sound type, and performs a relevant function of predetermined UI setting information corresponding to the extracted audio analysis data, thereby making it possible to control an operation of the portable terminal by simple hand action even in the case of emergencies or environments requiring silence.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for controlling an operation of a portable terminal using a microphone, comprising:
detecting an operation mode of the portable terminal and driving an audio recognition mode according to the detected operation mode to activate the microphone;
converting a contact or motion signal generated on or near the microphone into digital data and detecting audio characteristics from the converted digital data to extract audio analysis data for recognition of a type of the input signal; and
determining whether there is User Interface (UI) setting information corresponding to the extracted audio analysis data type, and performing a relevant function specified in the UI setting information according to the determination outcome.

2. The method of claim 1, wherein the audio analysis data is obtained by eliminating an interference noise from the digital data and amplifying the resulting data.

3. The method of claim 1, wherein the signal detected by the microphone comprises an audio signal that is generated by a pointing action of tap, drag, or click caused by an action of a user on or around the microphone.

4. The method of claim 1, wherein the UI setting information is a menu execution command predetermined depending on the characteristics of the audio analysis data.

5. The method of claim 4, wherein the predetermined menu execution command is a default menu predetermined in an initial operation of the portable terminal and is selectively reset for each type of a signal inputted from the microphone by the user.

6. The method of claim 1, further comprising allocating a new UI setting information to the extracted audio analysis data type if there is no UI setting information corresponding to the extracted audio analysis data type.

7. An apparatus for controlling an operation of a portable terminal using a microphone, comprising:
a microphone;
an analog/digital (A/D) converter converting a contact or motion signal, inputted from the microphone, into digital data;
a memory storing a menu execution command predetermined for each User Interface (UI) setting information type;
an audio data processor detecting the audio characteristics of the digital data outputted from the A/D converter and extracting audio analysis data from the detected data to recognize a type of the input signal; and
a controller detecting an operation mode of the portable terminal, driving an audio recognition mode according to the detected operation mode to activate the microphone, searching the memory to determine whether there is UI setting information corresponding to the extracted audio analysis data type, and performing a relevant function of the UI setting information on the basis of the information stored in the memory.

8. The apparatus of claim 7, wherein if there is no UI setting information corresponding to the extracted audio analysis data type, the controller allocates a new UI setting information to the extracted audio analysis data type.

9. The apparatus of claim 7, wherein the audio data processor comprises:
a noise eliminator eliminating an interference noise form the digital data outputted from the A/D converter; and
an amplifier amplifying the resulting signal obtained by the noise elimination,
wherein the noise eliminator and the amplifier are used to detect the audio characteristics to extract the audio analysis data.

10. The apparatus of claim 7, wherein the UI setting information is a menu execution command predetermined depending on the characteristics of the audio analysis data.

11. The apparatus of claim 7, wherein the signal inputted from the microphone is an audio signal that is generated by an action of tap, drag, click or scratch caused by an action of a user touching the microphone.

12. The apparatus of claim 7, wherein the audio analysis data is to be recognized as tap, drag, click, or scratch.

13. A method for controlling an operation of a portable terminal using a microphone, comprising:
detecting a contact or motion signal via the microphone and converting the detected signal into digital data;
determining a type of input signal corresponding to the converted digital data;
comparing the determined input signal type to a predetermined table having a plurality of User Interface (UI) setting information; and
if there is a match between the determined input signal type to one of the UI setting information, performing a corresponding function specified in the matched UI setting information.

14. The method of claim 13, wherein the signal detected by the microphone comprises an audio signal that is generated by a pointing action including a tap, drag, or click motion by a user.

15. The method of claim 13, wherein, if there is no match, storing a new UI setting information correspond to the extracted audio analysis data.
